(19) United States
(12) Patent Application Publication
(10) Pub. No.: US 2010/0322698 A1
(43) Pub. Date: Dec. 23, 2010

(54) WRITING INSTRUMENT WITH MAGNET INK AGITATOR

(76) Inventor: Michael Martin, Calgary (CA)

Correspondence Address: Maxey Law Offices, PLLC, 15500 Roosevelt Blvd., SUITE 305, CLEARWATER, FL, 33760, US

(21) Appl. No.: 12/486,562

(22) Filed: Jun. 17, 2009

(51) Int. Cl. B43K 23/02

(52) U.S. Cl. 401/131

(57) ABSTRACT

The writing instrument mountable to a ferrous surface includes an ink barrel of a non-ferrous material and first and second ends, an interior ink receiving space defined by an interior surface thereof, and a longitudinally extending axis. An agitator is positioned within the interior ink receiving space and is freely slidable therein for reciprocation along the longitudinally extending axis. The agitator includes a continuously open passage extending therethrough and generally in a direction from the first end towards the second end of the ink barrel. The agitator is a permanent magnet, whereby the writing instrument is detachably mountable to a surface of a ferrous material by a magnetic attraction between the surface of a ferrous material and the agitator when the ink barrel is positioned against the surface of a ferrous material.

### FIELD OF THE INVENTION

The present invention relates generally to writing instruments that are attachable to ferrous surfaces, and more particularly, relating to novel writing instrument having an improved construction including a permanent magnet agitator.

### BACKGROUND OF THE INVENTION

Writing instruments including numerous permanent magnetic arrangements for mounting a writing instrument to a ferrous surface or suspending a writing instrument above a surface exist in the prior art.

While existing writing instruments meet their intended purposes, a need still remains for a writing instrument mountable to a ferrous surface having an improved construction.

### SUMMARY OF THE INVENTION

In general, in one aspect, a writing instrument mountable to a ferrous surface of a novel and improved construction is provided. The writing instrument includes an ink barrel of a non-ferrous material and first and second ends, an interior ink receiving space defined by an interior surface thereof, and a longitudinally extending axis. An agitator is positioned within the interior ink receiving space and is freely slidable therein for reciprocation along the longitudinally extending axis. The agitator includes a continuously open passage extending therethrough and generally in a direction from the first end towards the second end of the ink barrel. The agitator is a permanent magnet, whereby the writing instrument is detachably mountable to a surface of a ferrous material by a magnetic attraction between the surface of a ferrous material and the agitator when the ink barrel is positioned against the surface of a ferrous material.

In general, in another aspect, a writing instrument mountable to a ferrous surface of a novel and improved construction is provided. The writing instrument includes an ink barrel of a non-ferrous material and first and second ends, an interior ink receiving space defined by an interior surface thereof, and a longitudinally extending axis. An agitator is positioned within the interior ink receiving space and is freely slidable therein for reciprocation along the longitudinally extending axis. The agitator includes a continuously open passage extending therethrough and generally in a direction from the first end towards the second end. The agitator is constrained against rotation that would result in the continuously open passage extending in a direction that is not generally from the first end towards the second end of the ink barrel. The agitator has a transverse cross-section that substantially fills a transverse cross-section of the ink receiving space without making sealing contact with the interior surface. The agitator is a permanent magnet, whereby the writing instrument is detachably mountable to a surface of a ferrous material by a magnetic attraction between the surface of a ferrous material and the agitator when the ink barrel is positioned against the surface of a ferrous material.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a side elevation view of a writing instrument constructed in accordance with the principles of the present invention mounted at one end to a ferrous surface by a magnetic agitator in a partial cross-section taken longitudinally along the writing instrument;

FIG. 2 is a transverse cross-section view taken along line 2-2 in FIG. 1 through the writing instrument and an agitator;

FIG. 3 is a transverse cross-section illustrating an alternate configuration of the agitator and an ink receiving space of the writing instrument;

FIG. 4 is a transverse cross-section illustrating an alternate configuration the agitator and an ink receiving space of the writing instrument;

FIG. 5 is a transverse cross-section illustrating an alternate configuration the agitator and an ink receiving space of the writing instrument; and

FIG. 6 is a side elevation view of the writing instrument mounted at a side to a ferrous surface by the magnetic agitator.

### DETAILED DESCRIPTION OF THE INVENTION

Reference will now be made in detail to the preferred embodiments of the present invention, examples of which are illustrated in the accompanying drawings.

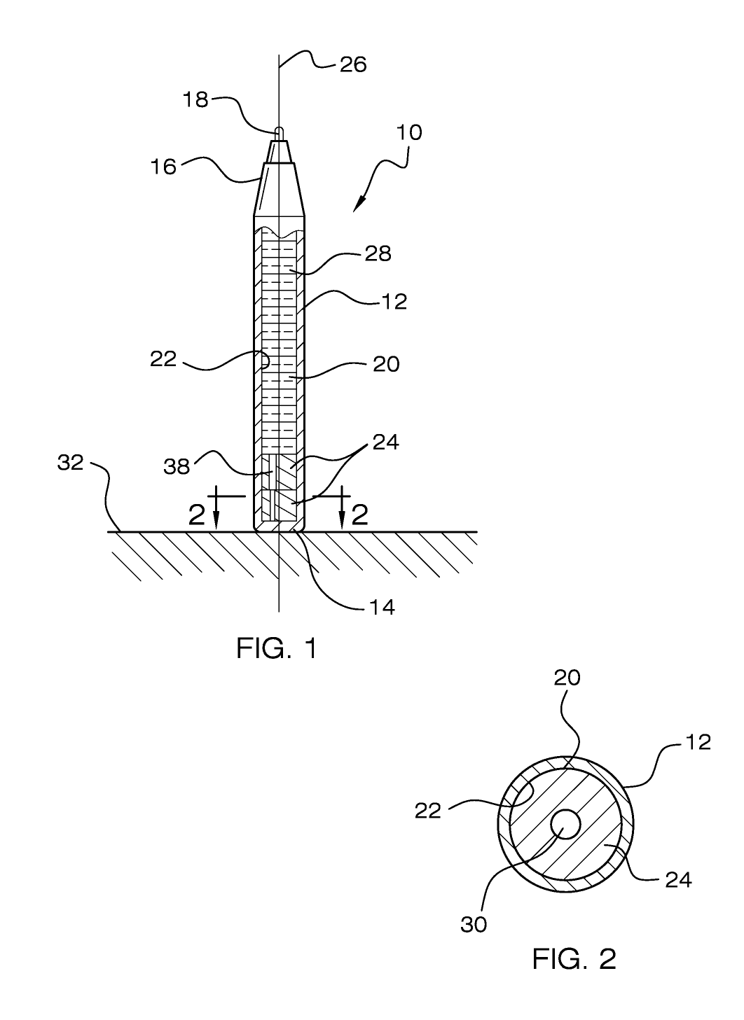

FIG. 1 is a side elevation view of a writing instrument 10 constructed in accordance with the present invention shown in partial longitudinal section taken through the writing instrument. The writing instrument 10 includes an ink barrel 12 and one or more agitators 24. The in barrel 12 is of suitable dimensions and of a non-ferrous material, such as plastic. The agitator 24 is a permanent magnet allows mounting of the writing instrument 10 to a ferrous surface, such as surface 32. One end 14 of the ink barrel 12 is closed. Mounted to end 16 opposite of end 14 is a suitable nib 18. At the interior of the ink barrel 12 there is an ink receiving space 20 defined by the interior surface 22 of the ink barrel for the reception of ink 28 therein.

An agitator 24 is positioned within the ink receiving space 20 and is freely slidable therein for reciprocation along a longitudinal axis 26 of the ink barrel 12. A continuously open passage 30 extends through the agitator in a direction from end 14 towards end 16 of the ink barrel 12. Reciprocation of the agitator 24 in the ink barrel 12 causes the ink 28 to be mixed or stirred. Passage 30 allows ink 28 to freely flow through the agitator 24 and prevent development of a pressure differential in the ink across the agitator during mixing of the ink, that otherwise could prevent the agitator from being freely slidable or cause ink to leak from the ink barrel 12. One or more agitators 24 can be positioned within the ink receiving space 20.

FIG. 2 is a transverse cross-section of the writing instrument 10 taken through agitator 24. The agitator 24 is a permanent magnetic that permits mounting of the writing instrument 10 to a ferrous surface by the magnetic attraction between the agitator 24 and the ferrous surface when the in barrel 12 is placed against the surface. To increase attraction forces, the agitator 24 has a transverse cross-section that substantially fills the transverse cross-section of the ink receiving space 20 without making sealing contact with the interior surface 22. In this manner, the agitator 24 is prevented from rotating about an axis other than the longitudinal axis 26, thereby maintaining correct positioning of passage 30. As shown in FIG. 2 both the ink receiving space 20 and the agitator 24 are circular-shaped in transverse cross-section. However, other transverse cross-sectional shapes are possible.

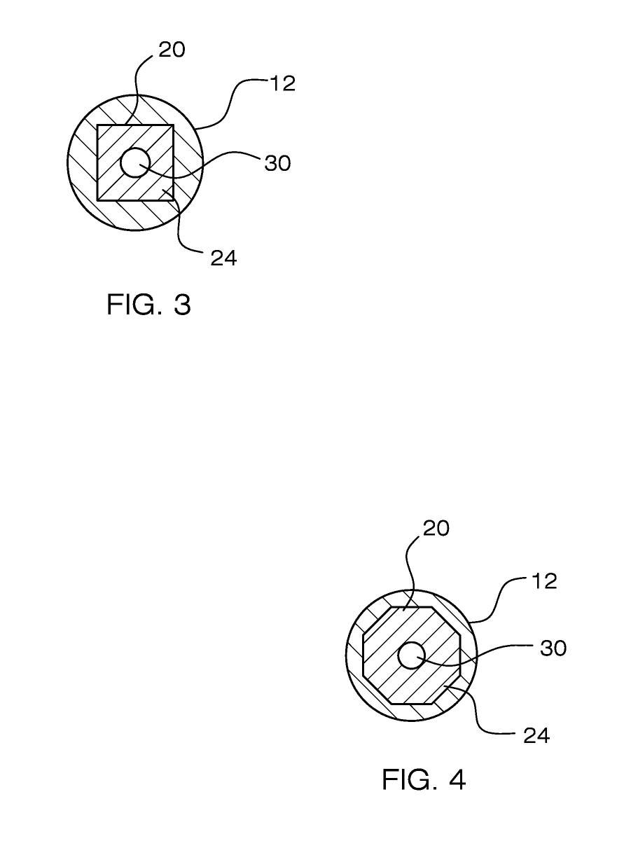

FIG. 3 is a transverse cross-section of the writing instrument 10 taken through agitator 24. As shown, both the ink receiving space 20 and the agitator 24 are square-shaped in transverse cross-section.

FIG. 4 is a transverse cross-section of the writing instrument 10 taken through agitator 24. As shown, both the ink receiving space 20 and the agitator 24 are hexagonal-shaped in transverse cross-section.

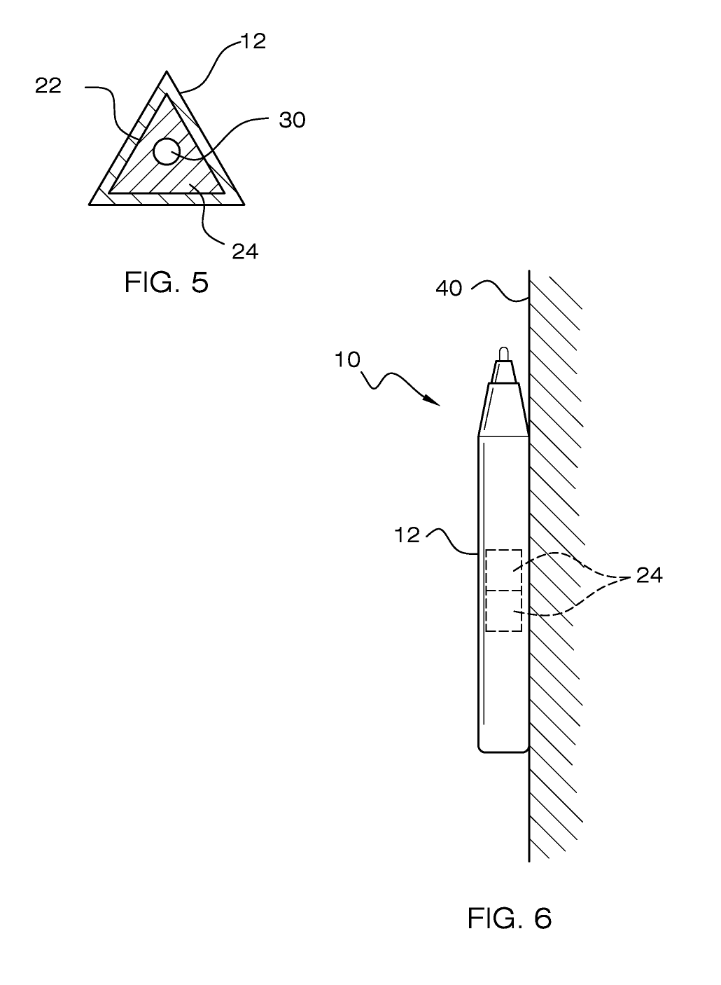

FIG. 5 is a transverse cross-section of the writing instrument 10 taken through agitator 24. As shown, both the ink receiving space 20 and the agitator 24 are triangular-shaped in transverse cross-section. Other transverse cross-sectional shapes are possible.

FIG. 6 is a side elevation view showing an alternating mounting of the writing instrument 10 than shown in FIG. 1 where therein end 14 of the writing instrument is positioned against surface 34 for mounting by the agitator 24. In FIG. 6, a side of the ink barrel 12 is positioned against surface 40 of a ferrous material for mounting by agitator 24.

A number of embodiments of the present invention have been described. Nevertheless, it will be understood that various modifications may be made without departing from the spirit and scope of the invention. Accordingly, other embodiments are within the scope of the following claims.

What is claimed is:

1. A writing instrument mountable to a ferrous surface, comprising:
an ink barrel of a non-ferrous material and having first and second ends, an interior ink receiving space defined by an interior surface thereof, and a longitudinally extending axis;
an agitator positioned within said interior ink receiving space and freely slidable therein for reciprocation along said longitudinally extending axis, said agitator defining a continuously open passage extending therethrough and generally in a direction from said first end towards said second end; and
wherein said agitator is a permanent magnet, whereby the writing instrument is detachably mountable to a surface of a ferrous material by a magnetic attraction between the surface of a ferrous material and said agitator when said ink barrel is positioned against the surface of a ferrous material.

2. The writing instrument of claim 1, further comprising:
a second agitator located within said interior ink receiving space and freely slidable therein along said longitudinally extending axis, said second agitator defining a continuously open passage extending therethrough and generally in a direction from said first end towards said second end; and
wherein said second agitator is a permanent magnet.

3. The writing instrument of claim 1, wherein said ink receiving space is circular-shaped in transverse cross-section, and wherein said agitator is circular-shaped in transverse cross-section, and further wherein said agitator is cylindrical-shaped.

4. The writing instrument of claim 1, wherein said ink receiving space is triangular-shaped in transverse cross-section, and wherein said agitator is triangular-shaped in transverse cross-section.

5. The writing instrument of claim 1, wherein said agitator is free from sealing contact against said interior surface.

6. The writing instrument of claim 1, wherein said agitator is constrained against rotation that would result in said continuously open passage extending in a direction that is not generally from said first end towards said second end of said ink barrel.

7. The writing instrument of claim 1, wherein said agitator has a transverse cross-section that substantially fills a transverse cross-section of said ink receiving space without making sealing contact with said interior surface.

8. A writing instrument detachably mountable to a ferrous surface, comprising:
an ink barrel of a non-ferrous material and having first and second ends, an interior ink receiving space defined by an interior surface thereof, and a longitudinally extending axis;
an agitator positioned within said interior ink receiving space and freely slidable therein for reciprocation along said longitudinally extending axis, said agitator defining a continuously open passage extending therethrough and generally in a direction from said first end towards said second end;
wherein said agitator is constrained against rotation that would result in said continuously open passage extending in a direction that is not generally from said first end towards said second end of said ink barrel;
wherein said agitator has a transverse cross-section that substantially fills a transverse cross-section of said ink receiving space without making sealing contact with said interior surface; and
wherein said agitator is a permanent magnet, whereby the writing instrument is detachably mountable to a surface of a ferrous material by a magnetic attraction between the surface of a ferrous material and said agitator when said ink barrel is positioned against the surface of a ferrous material.

9. The writing instrument of claim 8, wherein said ink receiving space is circular-shaped in transverse cross-section, and wherein said agitator is circular-shaped in transverse cross-section, and further wherein said agitator is cylindrical-shaped.

10. The writing instrument of claim 8, wherein said ink receiving space is triangular-shaped in transverse cross-section, and wherein said agitator is triangular-shaped in transverse cross-section.
